(19) United States
(12) Patent Application Publication
(10) Pub. No.: US 2016/0355384 A1
(43) Pub. Date: Dec. 8, 2016

(54) Pump Jack Pulley

(71) Applicant: Vyacheslav Blyshchyk, Everett, WA (US)

(72) Inventor: Vyacheslav Blyshchyk, Everett, WA (US)

(21) Appl. No.: 14/729,892

(22) Filed: Jun. 3, 2015

(51) Int. Cl. B66D 3/04

(52) U.S. Cl. CPC B66D 3/04

(57) ABSTRACT

With a pump jack pulley, contractors and employees would be able to load material onto the pulley and lift the material safely without putting a strain on their back. The pump jack pulley is very simple when it comes to design, but a high quality and reliable product. It can be manufactured for a fraction of the cost of the heavy machinery available, which would make it affordable and available to a wider range of construction laborers. This would allow for the product to be used throughout the full project, saving time and increasing efficiency.

### CROSS REFERENCE TO RELATED APPLICATIONS

Provisional Patent Application No. 62/009,067

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM

Not Applicable

### INVENTION BACKGROUND

### Field of Invention

The present invention is in the mechanical field, more specifically a device to lift items to various levels of scaffolding or other platforms.

### Problems this Invention Resolves

Currently, employees carry material up to the scaffolding table using a ladder, which is time consuming and puts a lot of strain on the back. Forklifts and other lifting machinery are available to do the job, but these heavy machinery are expensive and are rarely used for material that can be carried up.

### How the Problem was Resolved Before

Although lifting machinery is available, the expenses of such machinery prevent contractors and employees to rent them for construction projects and for the rare times that they are used, they are only rented for short periods of time and would not be available throughout most of the project.

### Why the Invention is Novel and Superiority of the Technology used to Solve the Problem

For where there is scaffolding and the need to lift items to workers there is no crane that is inexpensive, simple to erect, and as portable as the present invention.

With a pump jack pulley, contractors and employees would be able to load material onto the pulley and lift the material safely without putting a strain on their back.

The pump jack pulley is very simple when it comes to design, but a high quality and reliable product. It can be manufactured for a fraction of the cost of the heavy machinery available, which would make it affordable and available to a wider range of construction laborers. This would allow for the product to be used throughout the full project, saving time and increasing efficiency.

### Additional Benefits

This invention is simple to construct and can be used with or without a power assist.

### INVENTION SUMMARY

The present invention is a pump jack pulley. It is used to carry tools and materials to scaffolding table without the use of a ladder, which minimizes the number of trips and eliminates wasted time. The heavy lifting of construction material also decreases the risk of back injuries on the job.

### INVENTION DRAWINGS WITH NUMBERED COMPONENTS AND THEIR FUNCTIONALITY

### Brief Description of Figures

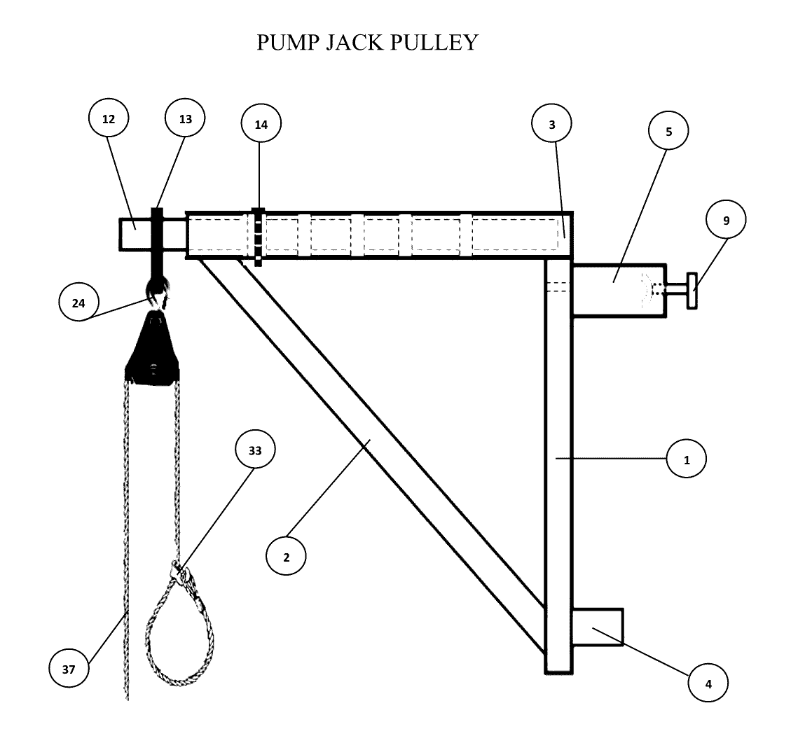

FIG. 1—BACK STRUCTURAL BAR, SERVES AS BACKBONE THAT CONNECTS MAIN PARTS

PART: 1—BACK STRUCTURAL BAR

PART: 2—SUPPORT BAR

PART: 3—TOP WEIGHT HOLDING BAR

PART: 4—BOTTOM PULLEY STABILIZER YOKE

PART: 5—U SHAPE BRACE YOKE

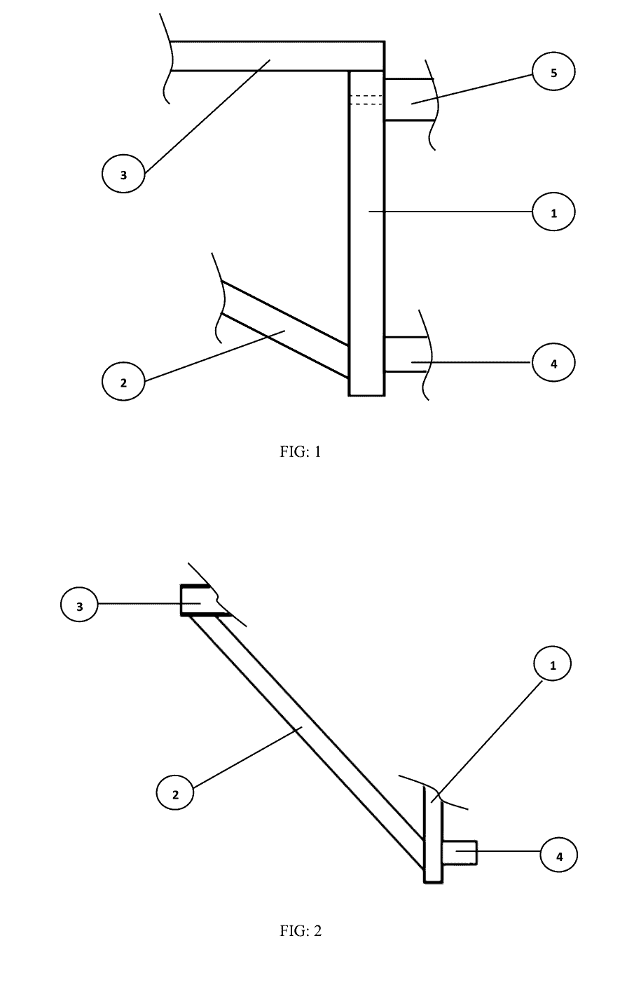

FIG. 2—SUPPORT BAR, SERVES AS SUPPORT BETWEEN TOP WEIGHT HOLDING

BAR AND BACK STRUCTURAL BAR

PART: 1—BACK STRUCTURAL BAR

PART: 2—SUPPORT BAR

PART: 3—TOP WEIGHT HOLDING BAR

PART: 4—BOTTOM PULLEY STABILIZER YOKE

FIG. 3—TOP WEIGHT HOLDING BAR WORKS IN CONJUNCTION WITH TOP EXTENDING BAR TO EXTEND LENGTH, ONE MAIN HOLE ON THE TOP WEIGHT HOLDING BAR FEEDS LOCK PIN THROUGH TO SECURE EXTENDING BAR

PART: 1—BACK STRUCTURAL BAR

PART: 2—SUPPORT BAR

PART: 3—TOP WEIGHT HOLDING BAR

PART: 5—U SHAPE BRACE YOKE

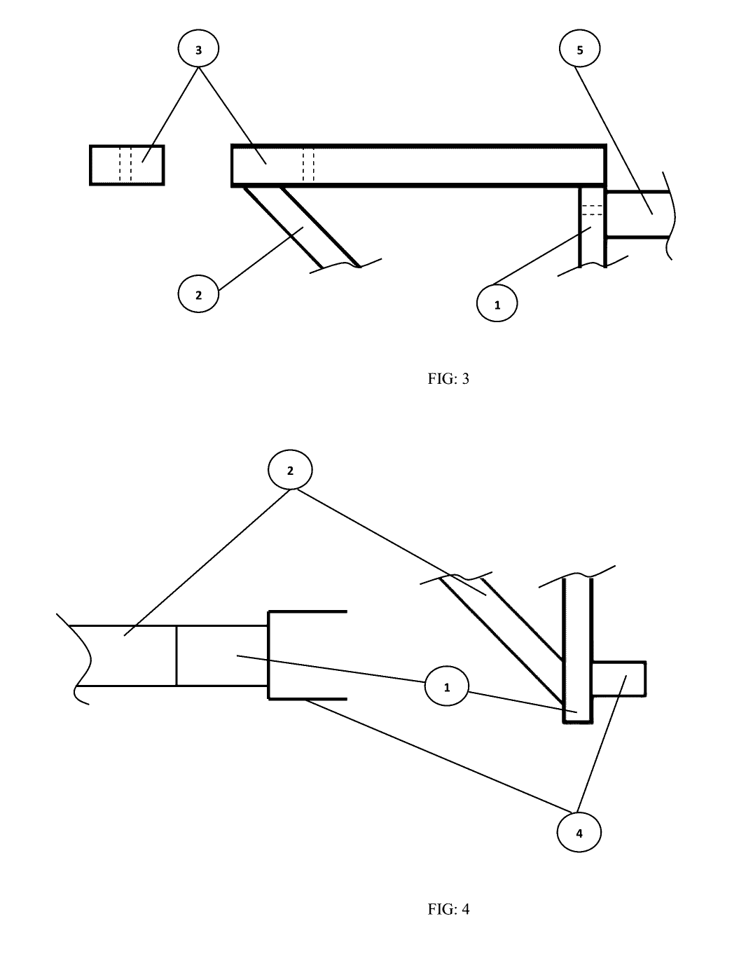

FIG. 4—BOTTOM PULLEY STABILIZER YOKE, ATTACHED TO BACK STRUCTURAL BAR TO STABILIZE BOTTOM OF PULLEY

PART: 1—BACK STRUCTURAL BAR

PART: 2—SUPPORT BAR

PART: 4—BOTTOM PULLEY STABILIZER YOKE

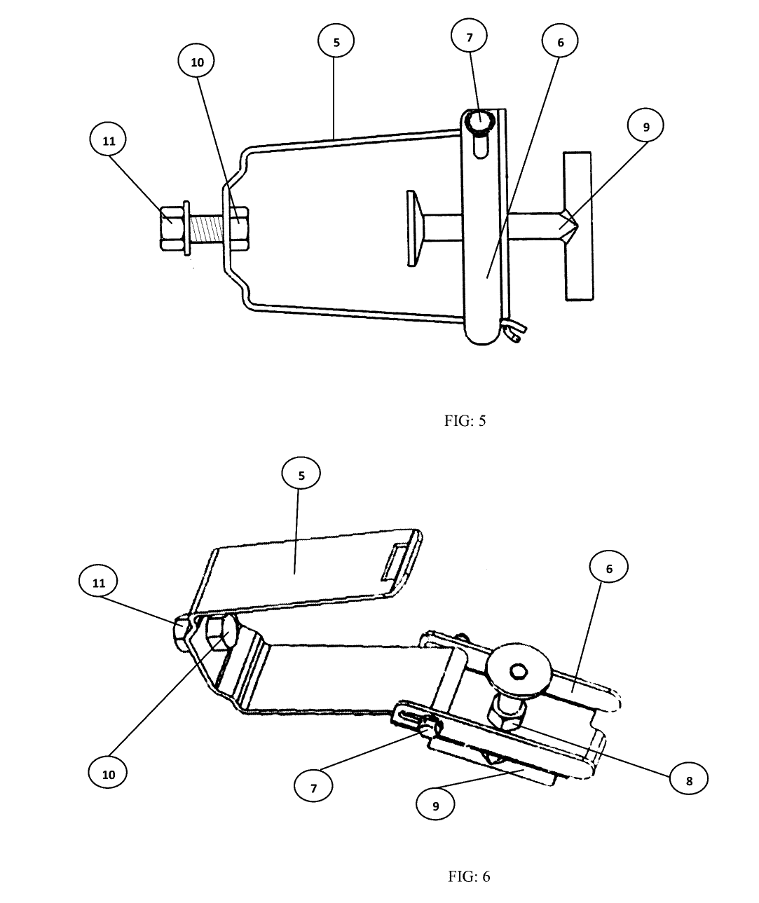

FIG. 5—BRACE LATCHED TO THE YOKE, HOLDS PULLEY TO PUMP JACK POLE

PART: 5—U SHAPE BRACE YOKE

PART: 6—BRACE LATCH WITH SLOT THAT ALOWS TO INSERT IT INTO YOKE SLOT, LATCH TAB KEEPS FROM MOVING

PART: 7—HINGE BOLT

PART: 9—THREADED HAND KNOB TIGHTENING SCREW TO TIGHTEN BRACE AGAINST THE POLE PART: 10—THREADED BRACE BOLT TO ATTACH BRACE TO BACK STRUCTURAL BAR

PART: 11—BRACE NUT TO ATTACH BRACE TO BACK STRUCTURAL BAR

FIG. 6—UNLATCHED BRACE

PART: 5—U SHAPE BRACE YOKE

PART: 6—BRACE LATCH

PART: 7—HINGE BOLT

PART: 8—THREADED HAND KNOB NUT

PART: 9—THREADED HAND KNOB

PART: 10—BRACE BOLT TO ATTACH BRACE TO BACK STRUCTURAL BAR

PART: 11—BRACE NUT TO ATTACH BRACE TO BACK STRUCTURAL BAR

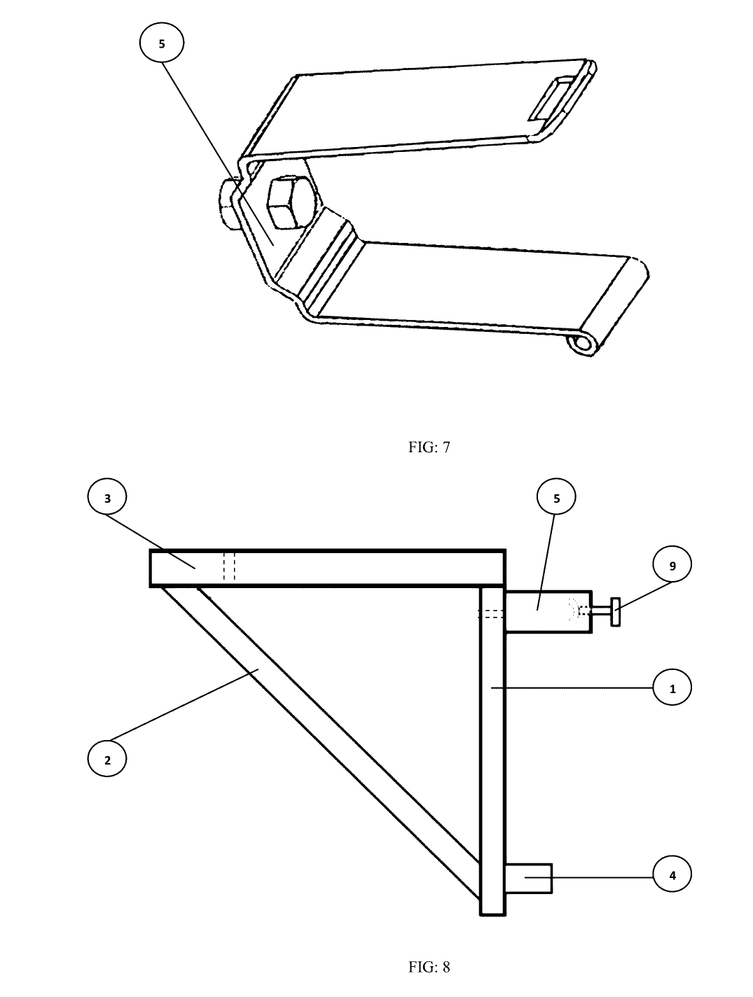

FIG. 7—BRACE U SHAPE YOKE WITH SLOT FOR LATCH TO INSERT AND SECURE THE LATCH, OPPOSITE SIDE OF THE SLOT HAS A LATCH HINGE

PART: 5—U SHAPE BRACE YOKE

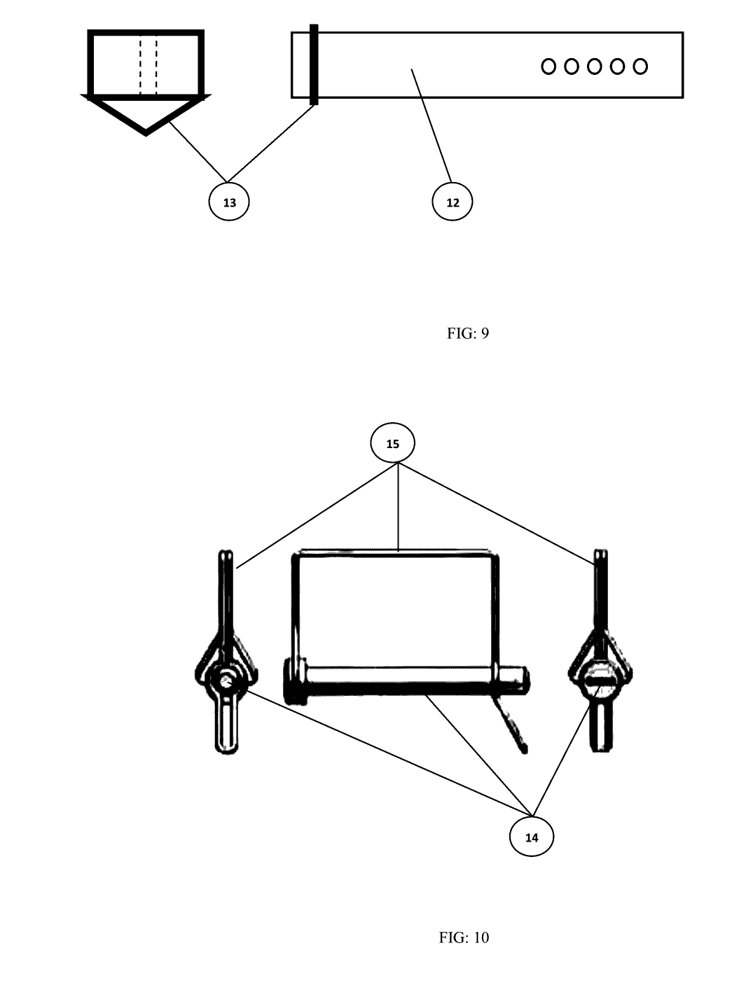

FIG. 8—PULLEY FRAME THAT WOULD BE WELDED TOGETHER BY

MANUFACTURER

PART: 1—BACK STRUCTURAL BAR

PART: 2—SUPPORT BAR

PART: 3—TOP WEIGHT HOLDING BAR

PART: 4—BOTTOM PULLEY STABILIZER YOKE

PART: 5—U SHAPE BRACE YOKE

PART: 9—THREADED HAND KNOB

FIG. 9—LENGTH ADJUSTING BAR THAT WOULD BE WELDED TOGETHER BY MANUFACTURER

PART: 12—TOP EXTENDING BAR WITH FIVE HOLES TO ADJUST THE LENGTH

PART: 13—TRIANGULAR HOOK TO ATTACH PULLEY ROPE BLOCK

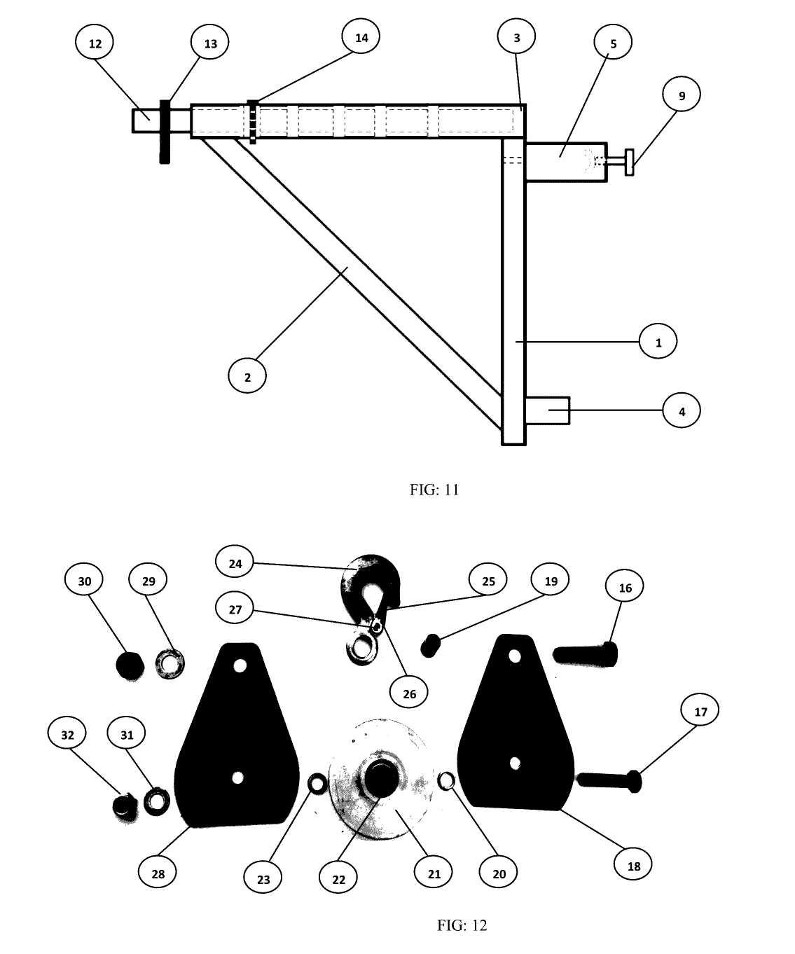

FIG. 10—SQUARE WIRE LOCK PIN, TO SECURE EXTENDING BAR ONCE LENGTH IS ADJUSTED

PART: 14—LOCK PIN

PART: 15—SQUARE WIRE

FIG. 11—LENGTH ADJUSTING BAR (FIG. 9) PLACED INTO TOP WEIGHT HOLDING

BAR AND LOCKED WITH SQUARE WIRE LOCK

PART: 1—BACK STRUCTURAL BAR

PART: 2—SUPPORT BAR

PART: 3—TOP WEIGHT HOLDING BAR

PART: 4—BOTTOM PULLEY STABILIZER YOKE

PART: 5—U SHAPE BRACE YOKE

PART: 9—THREADED HAND KNOB

PART: 12—TOP EXTENDING BAR

PART: 13—TRIANGULAR HOOK TO ATTACH PULLEY ROPE BLOCK

PART: 14—LOCK PIN

FIG. 12—PARTS OF PULLEY ROPE BLOCK

PART: 16—UPPER BOLT TO HOLD TOGETHER UPPER STRUCTURE AND BLOCK HOOK

PART: 17—BOTTOM BOLT TO HOLD TOGETHER BOTTOM STRUCTURE AND ROPE BLOCK WHEEL PART: 18—RIGHT STRUCTURE PLATE

PART: 19—CILINDER BOLT SPACER BETWEEN RIGHT AND LEFT PLATES

PART: 20—RIGHT SPACER, SITS BETWEEN RIGHT STRUCTURE PLATE AND ROPE BLOCK WHEEL

PART: 21—ROPE BLOCK WHEEL THAT ROTATES ROPE

PART: 22—BLOCK WHEEL BEARING

PART: 23—LEFT SPACER, SITS BETWEEN LEFT STRUCTURE PLATE AND ROPE BLOCK WHEEL

PART: 24—BLOCK HOOK

PART: 25—BLOCK HOOK LATCH THAT SECURES HOOK

PART: 26—BLOCK HOOK SPRING THAT RETURNS LATCH

PART: 27—BLOCK HOOK LOCK PIN

PART: 28—LEFT STRUCTURE PLATE

PART: 29—UPPER WASHER

PART: 30—UPPER LOCK NUT NYLON INSERT

PART: 31—BOTTOM WASHER

PART: 32—BOTTOM LOCK NUT NYLON INSERT

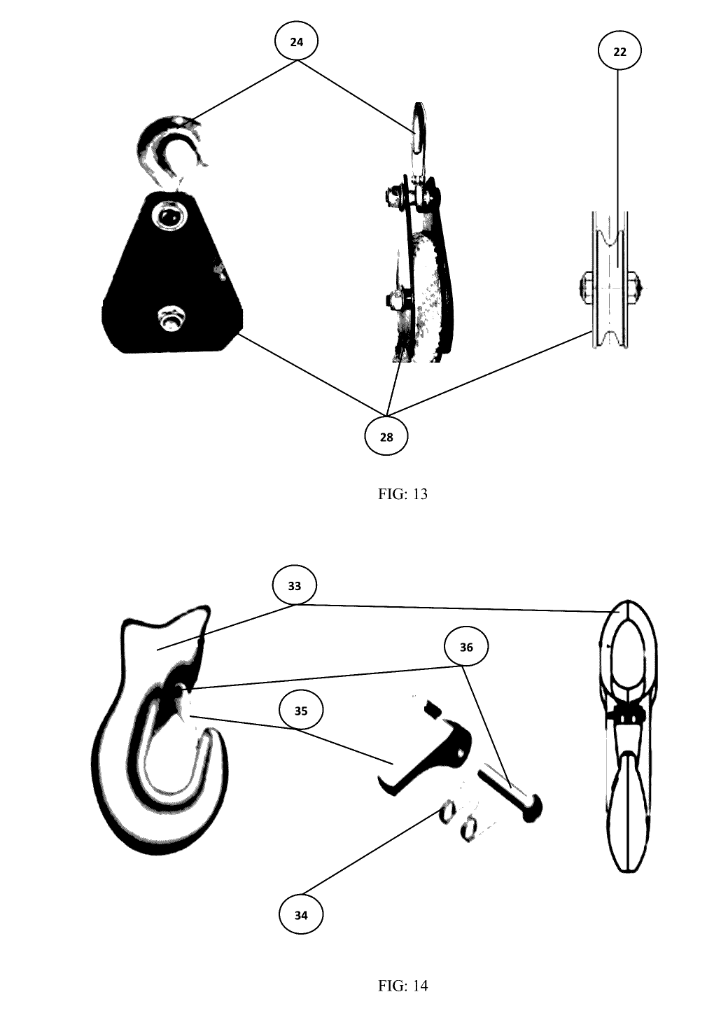

FIG. 13—DIFFERENT ANGLES OF PULLEY ROPE BLOCK AFTER IT IS ASSEMBLED BY MANUFACTURER

PART: 22—BLOCK WHEEL WITH BEARING

PART: 24—BLOCK HOOK

PART: 28—LEFT STRUCTURE PLATE

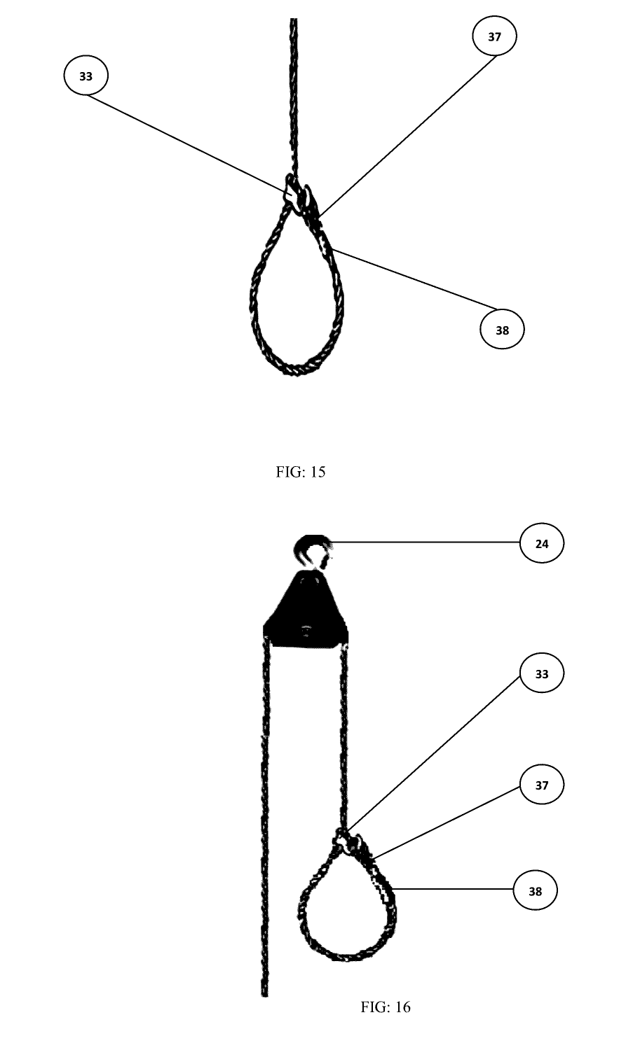

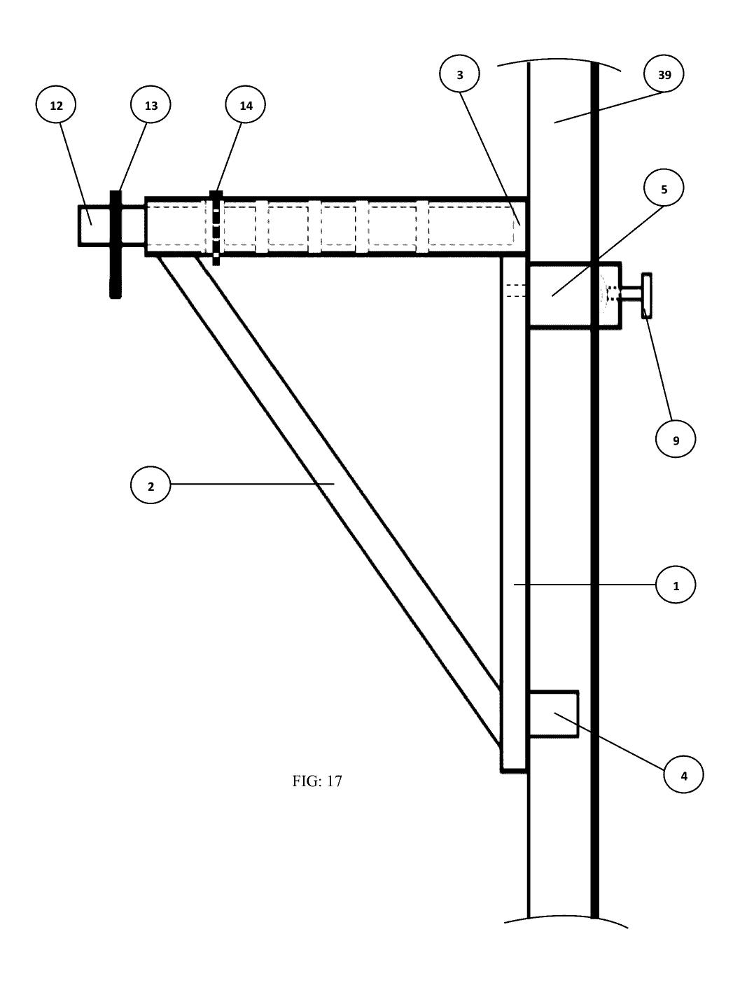

FIG. 14—3½-4LB SLIDING CHOKER HOOK WITH LATCH, RETURNS ROPE

PART: 33—BODY OF SLIDING CHOKER HOOK

PART: 34—CHOKER HOOK SPRING, TO RETRACT LATCH

PART: 35—CHOKER HOOK LATCH

PART: 36—CHOKER HOOK LOCK PIN

FIG. 15—MECHANISM THAT FEEDS ⅝ RAIDED POLY ROPE WITH LOOPED END THROUGH SLIDING CHOKER HOOK

PART: 33—BODY OF SLIDING CHOKER HOOK

PART: 37—⅝ RAIDED POLY ROPE WITH LOOPED END

PART: 38—CLAMP THAT HOLDS LOOP OF ROPE

FIG. 16—CHOCKER HOOK WITH ROPE IN FIG. 15 FEEDS THROUGH PULLEY ROPE BLOCK (FIG. 13)

PART: 24—BLOCK HOOK

PART: 33—BODY OF SLIDING CHOKER HOOK

PART: 37—⅝ RAIDED POLY ROPE WITH LOOPED END

PART: 38—CLAMP THAT HOLDS LOOP OF ROPE

FIG. 17—PULLEY FRAME TOGETHER WITH LOCKED LENGTH ADJUSTING BAR GETS ATTACHED SECURELY TO SCAFFOLDING POLE USING BRACE (PART: 39 NOT PART OF INVENTED PRODUCT)

PART: 1—BACK STRUCTURAL BAR

PART: 2—SUPPORT BAR

PART: 3—TOP WEIGHT HOLDING BAR

PART: 4—BOTTOM PULLEY STABILIZER YOKE

PART: 5—U SHAPE BRACE YOKE

PART: 9—THREADED HAND KNOB

PART: 12—TOP EXTENDING BAR

PART: 13—TRIANGULAR HOOK TO ATTACH PULLEY ROPE BLOCK

PART: 14—LOCK PIN

PART: 39—SCAFFOLDING POLE

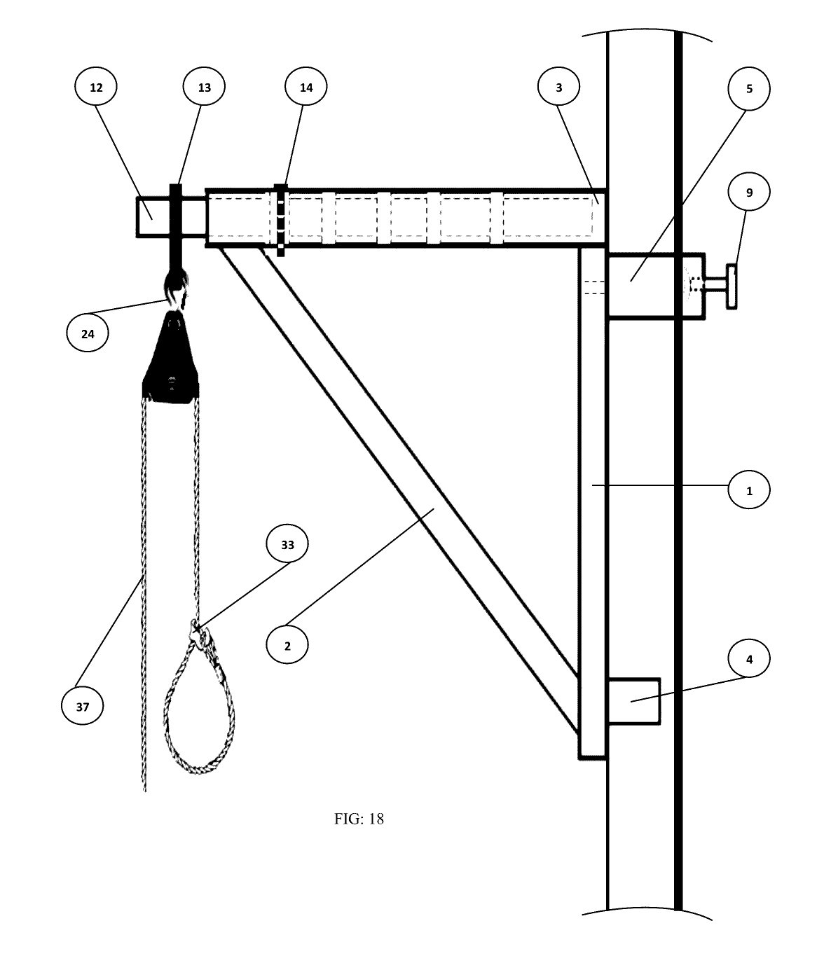

FIG. 18—CHOCKER HOOK WITH ROPE FED THROUGH PULLEY ROPE BLOCK GETS

LACHED ONTO TRIANGUAL HOOK

PART: 1—BACK STRUCTURAL BAR

PART: 2—SUPPORT BAR

PART: 3—TOP WEIGHT HOLDING BAR

PART: 4—BOTTOM PULLEY STABILIZER YOKE

PART: 5—U SHAPE BRACE YOKE

PART: 9—THREADED HAND KNOB

PART: 12—TOP EXTENDING BAR

PART: 13—TRIANGULAR HOOK TO ATTACH PULLEY ROPE BLOCK

PART: 14—LOCK PIN

PART: 24—BLOCK HOOK

PART: 33—BODY OF SLIDING CHOKER HOOK

PART: 37—⅝ RAIDED POLY ROPE WITH LOOPED END

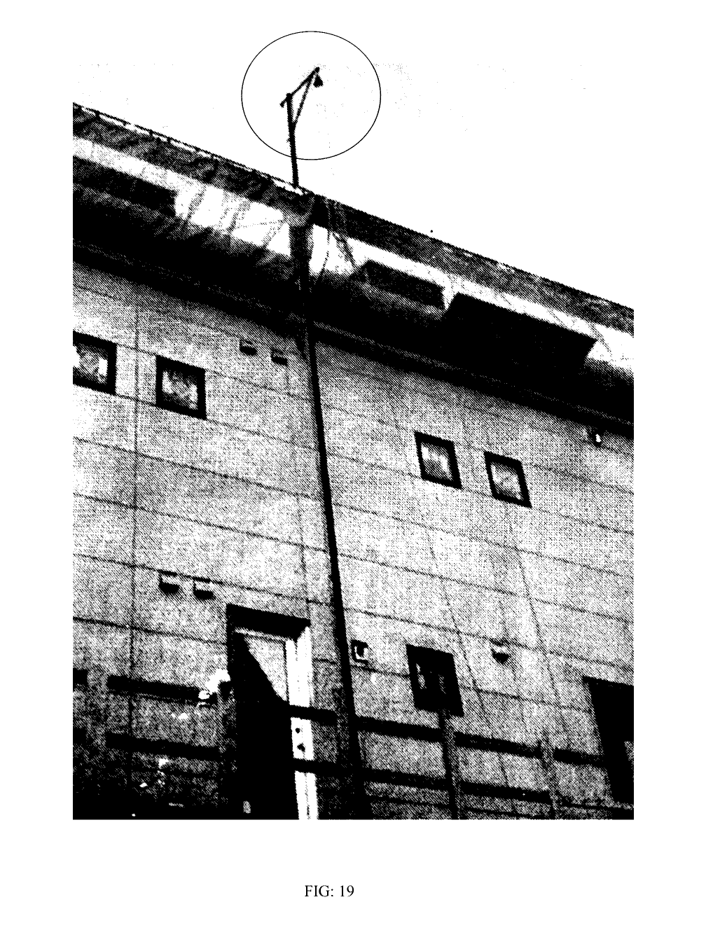

FIG. 19—REPRESENTATION OF INVENTION AS IT WOULD BE UTILIZED AT A CONSTRUCTION SITE

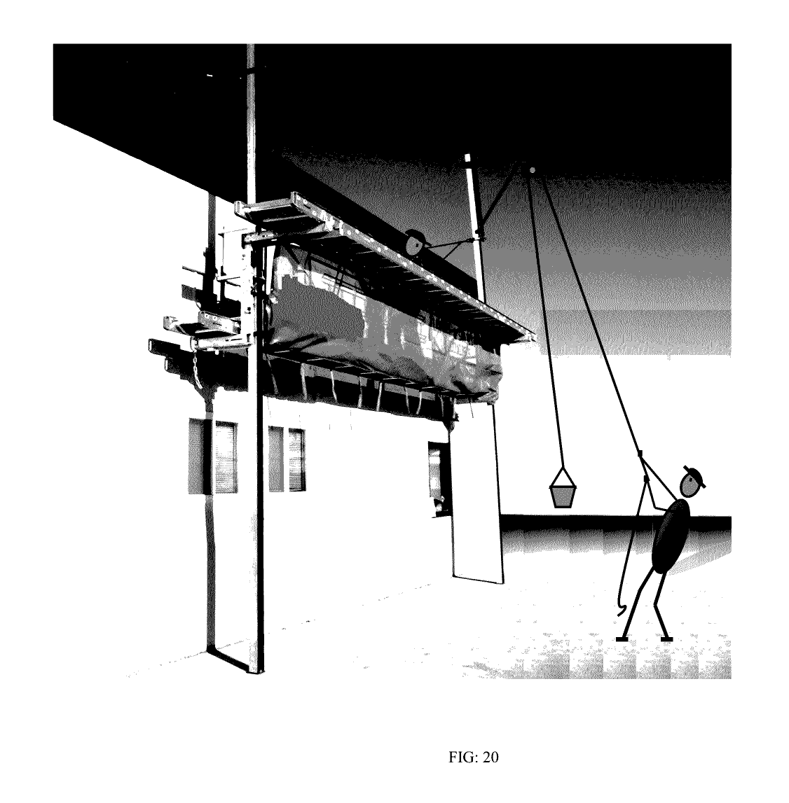

FIG. 20—PERSON ON GROUND LEVEL WOULD ATTACH WEIGHT TO CHOKER HOOK, PULL ON OTHER SIDE OF ROPE, WHILE PULLING WEIGHT UP, ANOTHER PERSON ON TOP OF SCAFFOLDING WOULD RECEIVE AND UNLOAD WEIGHT.

### INVENTION DESCRIPTION

The invention is a pump jack pulley. It is used to carry tools and materials to scaffolding table without the use of a ladder, which minimizes the number of trips and eliminates a time waste. The heavy lifting of construction material also decreases the risk of back injuries on the job.

### Assembly by Manufacturer

Step 1: Manufacturing of the BRACE, as shown in FIG. 5. One arm of the U-SHAPED YOKE (FIG. 7) needs a slot for insertion of LATCH-6 that would need to be secured. The opposite arm needs a HINGE. LATCH-6 needs to be attached with BOLT-7 that would go through the LATCH SLOT into HINGE and hold LATCH in place. LATCH-6 also needs a slot, the purpose of which is to allow insertion of latch into YOLK SLOT, and tab on opposite side would keep LATCH from moving.

Then, the THREADED HAND KNOB NUT 8 needs to be welded to LATCH 6, as shown in FIG. 6. THREADED HAND KNOB 9 would feed in to HAND KNOB NUT 8.

Step 2: Manufacturing of PULLEY FRAME, FIG. 8. A hole is to be drilled at the top of the BACK STRUCTURAL BAR-1 to attach the brace with THREADED BRACE BOLT-10 and BRACE NUT-11. FIG. 4 shows the BOTTOM PULLEY STABILIZER YOKE-4 that is to be attached to BACK STRUCTURAL BAR-1. FIG. 3 shows how to weld the TOP WEIGHT HOLDING BAR-3 to BACK STRUCTURAL BAR-1. TOP WEIGHT HOLDING BAR-3 needs to have one main hole that eventually will feed LOCK PIN (FIG. 10) through. The SUPPORT BAR-2 in FIG. 2 would serve as support between TOP WEIGHT HOLDING BAR-3 and BACK STRUCTURAL BAR-1.

Step 3: Manufacturing of LENGTH ADJUSTING BAR, FIG. 9. TOP EXTENDING BAR-12 needs five holes to be drilled, same length apart, to allow for length adjustment. TRIANGUAL HOOK-13 needs to be welded onto LENGTH ADJUSTING BAR-12 on the opposite side of drilled holes.

Step 4: Manufacturing of SQUARE WIRE LOCK PIN, FIG. 10. LOCK PIN-14 needs to have a hole at the head that keeps wire in place, but allows for locking and unlocking when necessary.

Step 5: Manufacturing of PULLEY ROPE BLOCK, FIG. 12. All parts of PULLEY ROPE BLOCK need to be manufactured and assembled into one piece. The UPPER BOLT-16 goes through the UPPER HOLE of RIGHT STRUCTURE PLATE-18. Then CILINDER BOLT SPACER-19 needs to be assembled onto the bold after it is fed through PLATE-18 to allow for space between structural plates.

To assemble BLOCK HOOK-24, the LOCK PIN-27 needs to be fed through LATCH-25 and SPRING-26. The BLOCK HOOK-24, once assembled, needs to be placed onto CILINDER BOLT SPACER-19.

Bottom BOLT-17 also needs to feed through bottom hole of RIGHT STRUCTURAL PLATE-18, followed by RIGHT SPACER-20. BLOCK WHEEL BEARING-22 needs to then be pressed into ROPE BLOCK-21. Once the BLOCK and BEARING are married together, they need to go onto BOTTOM BOLT-17, followed by SPACER-23.

The LEFT STRUCTURAL PLATE-28 that is identical to RIGHT STRUCTURAL PLATE-18 needs to be placed onto BOLT-16 and 17. The UPPER WASHER-29 needs to go onto the UPPER BOLT-16, and UPPER LOCK NUT NYLON INSERT-30 would be used to tighten both plates together. Same procedure to be repeated for parts on LOWER BOLT-17, parts include WASHER-31 and tightening of plates by LOWER LOCK NUT NYLON INSERT-32.

Step 6: Manufacturing of 3½—-4 LB SLIDING CHOKER HOOK WITH LATCH in FIG. 14. The CHOKER HOOK LOCK PIN-36 needs to be fed through CHOKER HOOK LATCH-35 and CHOKER HOOK SPRING-34 and placed onto the body of the SLIDING CHOKER HOOK-33.

Step 7: Making a loop with the ⅝ RAIDED POLY ROPE-37 and securing it with CLAMP-38, which will hold the loop of rope together, as per FIG. 15.

### How it Operates

The functionality of each part is described above in Section 4, Invention Drawing(s) with numbered components and their functionality.

### Set up of Pump Jack Pole Pulley on Project

The final product would be packaged in 6 separate pieces. These include: PULLEY FRAME, FIG. 8, LENGTH ADJUSTING BAR, FIG. 9, SQUARE WIRE LOCK PIN, FIG. 10, PULLEY ROPE BLOCK, FIG. 13, 3½-4 LB SLIDING CHOKER HOOK WITH LATCH, FIGS. 14, and ⅝ RAIDED POLY ROPE WITH LOOP, FIG. 15.

Step 1: Place LENGTH ADJUSTING BAR, FIG. 9, into PULLEY FRAME, FIG. 8, to lock EXTENDING BAR WITH SQUARE WIRE LOCK PIN, FIG. 10. Once length is adjusted, assembly should look as in FIG. 11.

Step 2: Secure product from FIG. 11 to scaffolding pole using BRACE. Product must be secured high enough above the working wall area, as per FIGS. 17, 19, and 20.

Step 3: Feed ⅝ RAIDED POLY ROPE WITH LOOPED END through SLIDING CHOKER HOOK, as per FIG. 15.

Step 4: Product from FIG. 15 gets fed through PULLEY ROPE BLOCK, as per FIG. 16.

Step 5: Product from FIG. 16 gets latched onto HOOK-13. Latching should be after pulley has already been attached to scaffolding pole. See FIG. 18.

FIGS. 19 and 20 show image of final set-up.

1. This description of my pump jack pulley gives a ‘person having an ordinary skill level in the art (35 USC 103(a))’ the ability to create and use the device in the best way possible. There can be variations, equivalents, and combinations of the device, so one should not take the above description as being the only way or form it can be created. That is, this description is but one representation of what can be done to produce the device to perform in the intended manner. In particular, this invention or its parts may be made of any material, size, shape, color, or weight, as long as the central purpose and function, and basic method of operation are retained, i.e., carry tools and materials to scaffolding table without the use of a ladder.
